(19) United States
(12) Patent Application Publication
(10) Pub. No.: US 2003/0050837 A1
(43) Pub. Date: Mar. 13, 2003

(54) Method and system providing advertisement using tone of ringing sounds of mobile phone and commerical transaction service in association with the same

(76) Inventor: Do Sik Kim, Seoul (KR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/220,859

(22) PCT Filed: Feb. 27, 2001
(86) PCT No.: PCT/KR01/00300

(30) Foreign Application Priority Data
Mar. 9, 2000 (KR) 2000-11769
Mar. 9, 2000 (KR) 2000-11781
Mar. 27, 2000 (KR) 2000-15410
May 31, 2000 (KR) 2000-29595

(51) Int. Cl. G06F 17/60; H04M 3/42; H04Q 7/20

(52) U.S. Cl. 705/14; 455/414; 455/422

(57) ABSTRACT

A method and system providing an advertisement using a tone of ringing sounds of a mobile phone terminal, and a commercial transaction service in association with the same, is provided. An advertisement is output instead of an incoming call ring sound which rings when a user of the mobile phone terminal receives the call, or for a predetermined time from start of an outgoing call which is achieved by pressing a telephone number of a called party and a SEND button for making a phone call to reception of a response signal of the called party, and a benefit bestowed to the user according to the advertisement listening or watching is spread to product purchase to thereby enhance an advertisement effect. Preferably, an advertisement or melody in the form of music, message, still images and motion images is downloaded in the mobile phone terminal and the downloaded advertisement or melody is listened to or watched instead of an incoming call sound or until a call is accomplished after a phone call has been transmitted. The number of times of listening to or watching the advertisement is counted and actual purchase on an on-line or off-line of a corresponding advertisement product of a member who has listened to or watched is deposited together with the advertisement listening or watching number of times, to thereby provide a variety of benefits such as a phone call fee reduction, a cash back, a milage point, a subsidy of purchase of a new terminal. Thus, the maximum advertisement effect can be heightened without having no harm to call, and the utmost service can he provided so that a benefit on purchase is bestowed to a member who listens to or watches the advertisement via a phone call fee discount and a point/milage deposit with respect to purchase transaction on the on-line and off-line commercial transaction system.

### DESCRIPTION

1. Technical Field

The present invention relates to an advertisement using a mobile phone terminal such as a cellular phone or a PCS phone, and more particularly, to a method and system providing an advertisement using a tone of ringing sounds of a mobile phone terminal, and a commercial transaction service in association with the same, in which an advertisement or a melody is output for a predetermined time during generation of a tone of ringing sounds before a phone call has been sent or received via the mobile phone terminal, to thereby enable a caller or a receiver to hear or watch the advertisement or the melody, and various advantages are given with respect to an on-line or off-line purchase in association with the advertisement, to thereby further enhance an advertisement effect without harming the phone call.

2. Background Art

A variety of advertisement methods using a telephone call have been already disclosed. That is, one is a free phone calling method in which a particular device allowing a user to listen to advertisements is installed at home or office and if the user listens to the advertisements a several-minute free phone call is allowed in return to the listening of the advertisements. Also, in the case of mobile phones, a service company dials up a mobile phone terminal of a subscriber to make the subscriber listen to an advertisement and pays a predetermined advertisement listening fee for every listening. Also, there is a method providing a free phone call service in which an advertisement is inserted periodically during phone calls of subscribers who subscribe as memberships in advance and a free phone call service is provided in return to the listening of the advertisement.

The above conventional free phone call service requires a particular device which is installed separately. Since a user has to listen to an advertisement for a predetermined time during a direct phone call, in order to use a free phone call service, he or she should tolerate for the advertisement listening time even in the case of an emergency call. Further, an advertisement which is inserted compulsively during a phone call may interrupt the call for an advertisement insertion time.

### DISCLOSURE OF INVENTION

To solve the above problems it is an object of the present invention to provide a method providing an advertisement using a tone of ringing sounds of a mobile phone terminal, and a commercial transaction service in association with the same, in which an advertisement or a melody other than a ringing tone is output for a predetermined time during generation of the tone of ringing sounds in the range without affecting a user's call, to thereby enable a caller or a receiver to listen to or watch the advertisement or the melody, and various advantages are given with respect to the listening and watching of the advertisement and a purchase in which a commercial transaction of purchasing a product is in association with the listening and watching of the advertisement, to thereby further enhance an advertisement effect.

It is another object of the present invention to provide a system providing an advertisement using a tone of ringing sounds of a mobile phone terminal, and a commercial transaction service in association with the same.

To accomplish the above object of the present invention, there is provided a method providing an advertisement using a tone of ringing sounds of a mobile phone terminal, and a commercial transaction service in association with the same, the advertisement and commercial transaction providing method comprising the steps of: (a) accessing an advertisement service provider, downloading an advertisement and storing the downloaded advertisement; (b) outputting the advertisement stored in step (a) as a phone call reception ringing tone and outputting the advertisement stored in step (a) as a phone call transmission ringing tone for a predetermined time to make a caller and a receiver listen to or watch the advertisement: (c) interrupting the advertisement which is output in step (b) if a phone call is connected between the caller and the receiver: (d) counting the number of the listening and watching of the advertisement in step (b) and notifying the counted result to the advertisement service provider: (e) purchasing a product of a sponsor company in association with the listening and watching of the advertisement in step (b); and (f) providing advantages designated with respect to the number of the listening and watching of the advertisement in step (d) and the purchase of the product in step (e).

To accomplish the other object of the present invention, there is also provide a system providing an advertisement using a tone of ringing sounds of a mobile phone terminal, and a commercial transaction service in association with the same, the advertisement and commercial transaction providing system comprising: a system operator for selecting an appropriate advertisement among prestored advertisements, downloading the selected advertisement to a mobile phone terminal which is designated by a subscriber accessed to the system operator, and providing advantages determined with respect to listening and watching the downloaded advertisement and purchasing a product; the mobile phone terminal outputting the stored advertisement as a phone call reception ringing tone, and outputting the advertisement stored as a phone call transmission ringing tone for a predetermined time, to make a caller and a receiver listen to or watch the advertisement, counting the number of the listening and watching of the advertisement, and notifying the counted result to the system operator; a connector connecting between the system operator and the mobile phone terminal, and a commercial transaction system operator providing a purchase and service of products of a sponsored company of the system operator, and providing advantages which are provided during purchase and use of the product and service to the system operator.

### BRIEF DESCRIPTION OF DRAWINGS

The above objects and other advantages of the present invention will become more apparent by describing the preferred embodiments thereof in more detail with reference to the accompanying drawings in which:

FIG. 1 is a diagram showing the whole system to which the present invention is applied;

FIG. 2 is a detailed block diagram showing a mobile phone terminal used in the FIG. 1 system;

FIG. 3 is a flowchart view for explaining an advertisement download procedure of the mobile phone terminal;

FIGS. 4A through 4B are views for explaining an incoming call signal and an outgoing call signal of a mobile phone terminal;

FIG. 5 is a flowchart view for explaining an advertisement method using an incoming call ringing tone of the mobile phone terminal according to an embodiment of the present invention;

FIG. 6 is a flowchart view for explaining an advertisement method using a predetermined time between a starting time of an outgoing call signal and a reception time of an incoming call from a called party in the mobile phone terminal: and

FIG. 7 is a flowchart view for explaining a purchase of a product in association with listening to and watching an advertisement and a compensation procedure of the listening and watching of the advertisement and the product purchase in association with the advertisement.

### BEST MODE FOR CARRYING OUT THE INVENTION

Preferred embodiments of the present invention will be described with reference to the accompanying drawings.

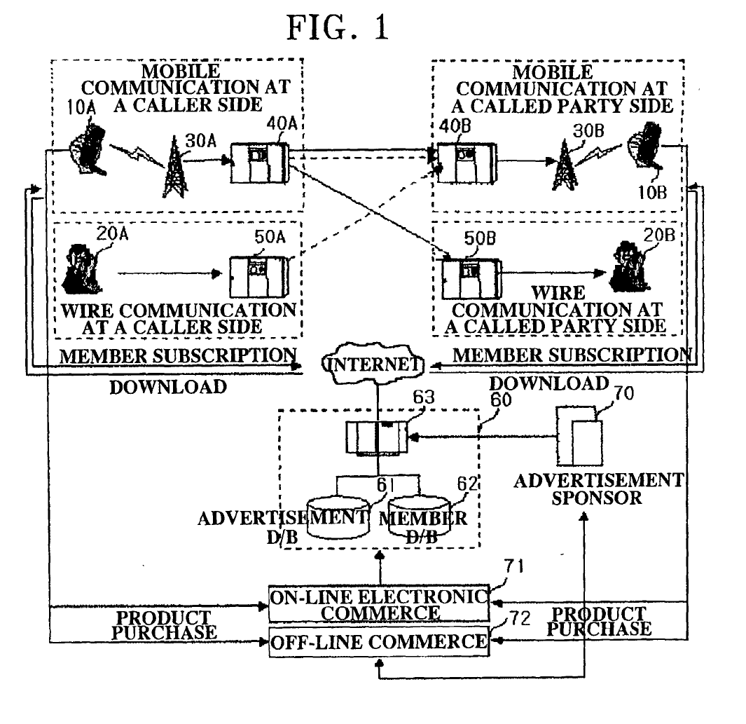

FIG. 1 is a diagram showing the whole system to which the present invention is applied. The system shown in FIG. 1 includes mobile phone terminals 10A and 10B such as cellular phones and PCS phones and general phone terminals 20A and 20B, of users respectively at an outgoing call signal side and an incoming call signal side, base stations 30A and 30B and wireless exchangers 40A and 40B, respectively at a transmission and reception sides for connecting phone calls of the mobile phone terminals 10A and 10B, exchangers 50A and 50B respectively at a transmission and reception sides, and a system operator 60 for providing an advertisement download service to the mobile phone terminals 10A and 10B. The system operator 60 includes an advertisement database 61 for storing, various kinds of advertisements such as music data, messages, motion pictures, still pictures which are provided from advertisers 70 as a database, a member database 62 for storing subscribers information subscribed via the Internet, telephone and facsimile connections as a database, and an operator server 63 for controlling the whole system. Here, the mobile phone terminals 10A and 10B should be able to perform a download and message processing. When an existing terminal is used, the software in the terminal should be able to be upgraded in order to support the download and message processing. The FIG. 1 system includes an on-line commercial transaction system 72 and an off-line commercial transaction system 72 for enabling users to purchase a corresponding advertisement product in association with the listening, and watching of the advertisement on the on-line and off-line and authenticating an advantage with respect to the purchase to then be transferred to the system operator 60.

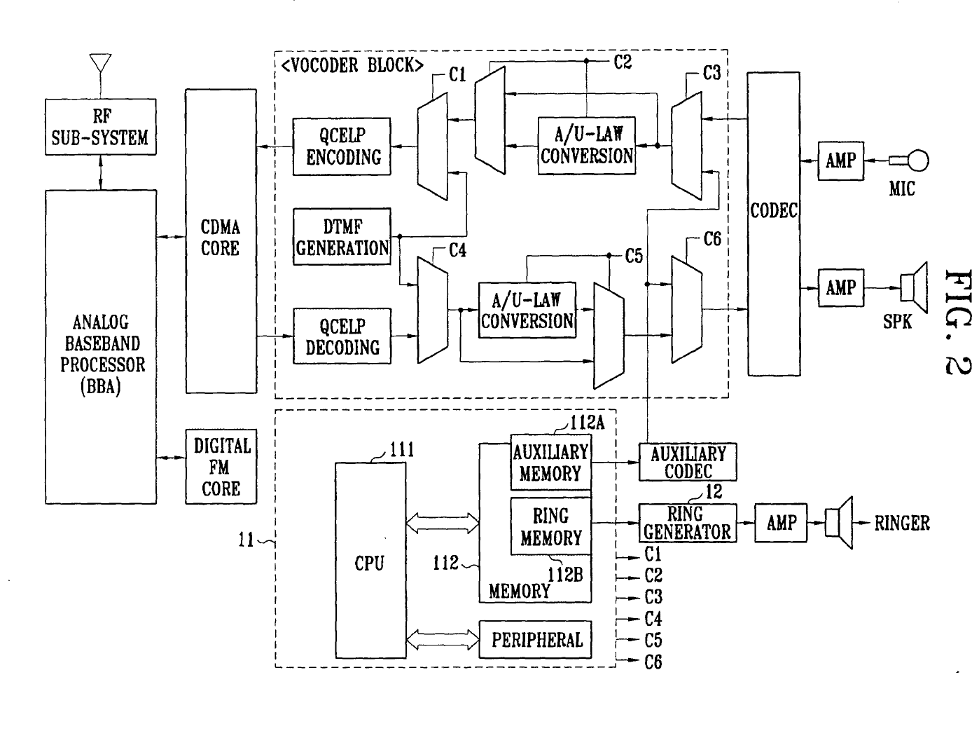

FIG. 2 is a detailed block diagram showing a mobile phone terminal 10A or 10B used in the FIG. 1 system. The FIG. 2 mobile phone terminal includes all elements of a general mobile phone terminal, and a control block 11 including a memory 112 for storing a downloaded advertisement and a central processing unit (CPU) 111 having a software for outputting the downloaded advertisement insead of an incoming and outgoing call signal for a predetermined time during generation of the incoming and outgoing call signal. The memory 112 includes an auxiliary memory 112A and a ring memory 112B storing a melody used as an incoming ring tone. Here, the mobile phone terminal 10A or 10B is designed as two kinds of modes such as a general mode (mode1) and a service dedicated mode (mode2). That is, the mobile phone terminal operates in a general mode (mode1) usually, and if a user is subscribed as a member to receive an advertisement service and downloads an advertisement file, the mobile phone terminal is operated in a service dedicated mode (mode2). In the case that the user tries to change the mode from the service dedicated mode (mode2) to the general mode (mode1) again, the user may access the system operator 60 to select a stop of use in the service dedicated mode.

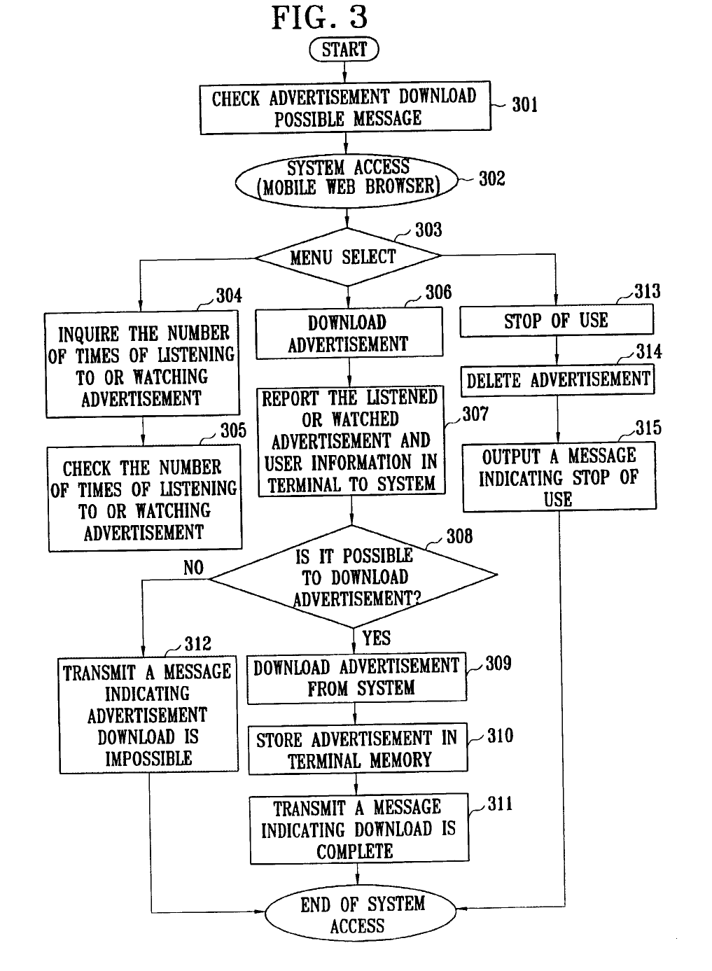

In FIG. 1, a member database 62 for storing subscribers' information subscribed via the Internet, telephone and facsimile connections should be firstly constructed to provide an advertisement service. Then, an advertisement database 61 for storing various kinds of advertisements such as music data, messages, motion pictures, still pictures which are provided from advertisers 70 should be constructed. Users register personal information including name, sex, job, hobby, etc., and subscribes as members, by accessing a home page of an Internet operator or by use of a telephone and facsimile machine. The personal information of the subscribed member is constructed as a database of the member database 62 in the system operator 60 and is used for selecting an advertisement to be downloaded later. The user properly corrects the software in the mobile phone terminal 10A or 10B, downloads the advertisement contained in the advertisement database 61 of the system operator 60, stores the downloaded advertisement in the mobile phone terminal, and generates the stored advertisement before connection of a phone call between a caller and a receiver, to thereby listen to or watch the advertisement. There are various methods for downloading an advertisement in the mobile phone terminal 10A or 10B. One of them is to access an ARS system and download an advertisement via the ARS system. Another is to download and store an advertisement sound as if sound signals are stored as conversation contents. Still another method is to download an advertisement in a PC using the Internet and use an interface such as a serial port by cable. The other method is to download an advertisement using a mobile web browser. The ARS is chiefly used during downloading a melody. In the case of the melody, a buzzer rings by combination of two frequencies to generate a sound, in which a short message service (SMS) is chiefly used since a quantity of data is very small. In the case of the second method, since a sound is downloaded and stored, a quality of the sound is lowered according to the line state. The third method is used for downloading a MP3 file at present, but is inconvenient since it should connect a cable to the PC. In the final method, an advertisement is downloaded after a mobile phone terminal is connected to a system operator, using a mobile web browser such as a WAP or Web. Accordingly, this method can transfer a sound file most stably among the above advertisement downloading methods. A file can be downloaded using a SMS in the case that it is difficult to load the file by use of a mobile web browser. In this embodiment, an advertisement downloading procedure in the mobile phone terminal 10A or 10B, using a mobile web browser will be described with reference to FIG. 3.

In FIG. 3, a user who is subscribed as a member, that is, a subscriber ascertains an advertisement download acceptable message from the system operator 60 (step 301). Then, the subscriber accesses the system operator 60 via a mobile web browser on the Internet (step 302). In step 301, a user being a new member confirms the advertisement download acceptable message by receiving a SMS from the system operator 60 and a user being an existing member confirms the advertisement download acceptable message by making the mobile phone terminal 10A or 10B generate an advertisement listening and watching completion alarm message or by receiving a SMS which states that an advertisement can be downloaded from the system operator 60. At the state when the system has been accessed, the operator server 63 in the system operator 60 transfers a menu with which a subscriber can select (step 303). The accessed subscriber selects a desired menu according to his or her access purpose. If a subscriber selects a number of times of listening and watching an advertisement (step 304), the operator server 63 transfers the number of times of listening and watching the advertisement to the subscriber, to thereby make the subscriber confirm it (step 305). If the subscriber selects an advertisement download (step 306), the advertisement which has been completely listened to and watched in the mobile phone terminal 10A or 10B and the subscriber's membership information are transferred and reported to the operator server 63 (step 307). The operator server 63 confirms whether the subscriber is an advertisement download acceptable user through the completely listened and watched advertisement and the user information reported from the user (step 308). If it is confirmed that the subscriber is an advertisement download acceptable user in step 308, the operator server 63 selects an advertisement appropriate for the user from the advertisement database 61, based on the reported user information to then be downloaded in the corresponding mobile phone terminal 10A or 10B (step 309). Here, the user information is used for selecting an advertisement appropriate for the user among the advertisements registered in the advertisement database 61. Tile mobile phone terminal 10A or 10B stores the downloaded advertisement in a memory 112 of the control block 11 (step 310). In step 308, if it is confirmed that the subscriber is an advertisement download rejected user since the downloaded advertisement is still left in the mobile phone terminal 10A or 10B, or the advertisement has been listened to or watched up to a monthly limit, the operator server 63 transfers an advertisement download rejected message (step 312), and terminates the access. The operator server 63 can change the contents of the advertisement by day week, month or season and transfer the changed advertisement, and manages the system so that an advertiser's desired object and the downloaded user is identified with each other. For example, the member database 62 searches the age and sex of the user. If the user is a woman in the twenties, a cosmetic advertisement is transferred, but if the user is a man in the twenties, a sports advertisement is transferred. In this manner, the contents of the advertisement are classified and transferred. If an advertisement to be downloaded is completely transferred, the operator server 63 generates a guiding message informing that the downloading is completed to have the subscriber ascertain that the downloading is successfully performed (step 311) to then terminate the connection of the system. If the downloading has been completed, the mobile phone terminal of the user is automatically converted into a service mode (mode2), so that an advertisement stored in advance before the phone call is generated to have the user listen to or watch it. Meanwhile, if a subscriber selects an advertisement service use stop in the menu of step 303 (step 313), an advertisement deletion program is downloaded to the accessed mobile phone terminal 10A or 10B (step 314). If the use stop program has been completed, the operator server 63 generates a cancel completion message to inform the subscriber that the service mode (mode2) has been cancelled (step 315), to then terminate the system connection. The mobile phone terminal of the user who has performed the above procedure is converted into a general mode (mode1), to then have the user listen to or watch a general outgoing call sound or an incoming call sound until a phone call is made.

The advertisement downloaded via the above process is stored in a memory 112 within the control block 11 of the mobile phone terminal 10A or 10B shown in FIG. 2. The stored advertisement is generated for a predetermined time from start of an outgoing call signal to reception of an incoming call signal, instead of the incoming call sound of the mobile phone terminal 10A or 10B An incoming call sound rings when a caller makes a phone call to the mobile phone terminal 10B, by use of the mobile phone terminal 10A or a general telephone terminal 20A, and the procedure is as follows.

When a caller makes a phone call in the mobile phone terminal 10A, an incoming call sound is transferred to the exchanger 40B or 50B via the base station 30A and an exchanger 40A. When a caller makes a phone call in the general telephone terminal 20A, an incoming call sound is transferred to the exchanger 40B or 50B via an exchanger 50A. The exchanger 40B at the incoming side notifies a call is transferred to the mobile phone terminal 10B via the base station 30B. Here, the mobile phone terminal 10B at the reception side calls out one of the incoming call sound melodies stored in a ring memory 112B so that a called party can recognize an incoming phone call and then generates a ring sound via a ring generator 12 so that the mobile phone terminal 10B rings. In the case of the mobile phone terminal, it takes about 20 through 40 seconds from the time when a caller listens to or watches an initial incoming call sound to the time when the base station recognizes that a called party is absent to then stop the incoming call sound. Meanwhile, the exchanger 50B at the reception side transfers a call directly to the general telephone terminal 20B. In one embodiment of the present invention the above time taken from start to stop of the incoming call sound is used as an advertisement time. Meanwhile, in the case that a user makes a phone call in the mobile phone terminal 10A, there is a non-sound state of about 3-5 seconds until the mobile phone terminal 10A communicates a message with the base station 30A after the user has started to call up, and also it takes about 3-5 seconds as a paging time until a response reaches from a called party. Thus, a user should await that an outgoing call sound rings for about 6-10 seconds after a receiver in the mobile phone terminal is located close to the ear. In the other embodiment of the present invention, the above paging time is also used as an advertisement time.

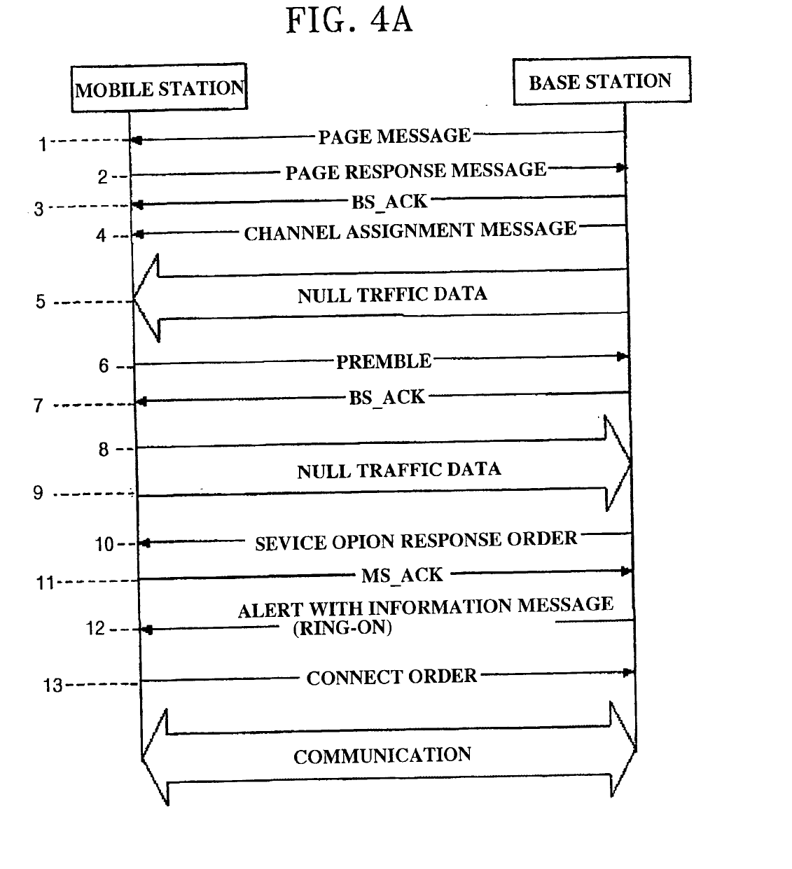

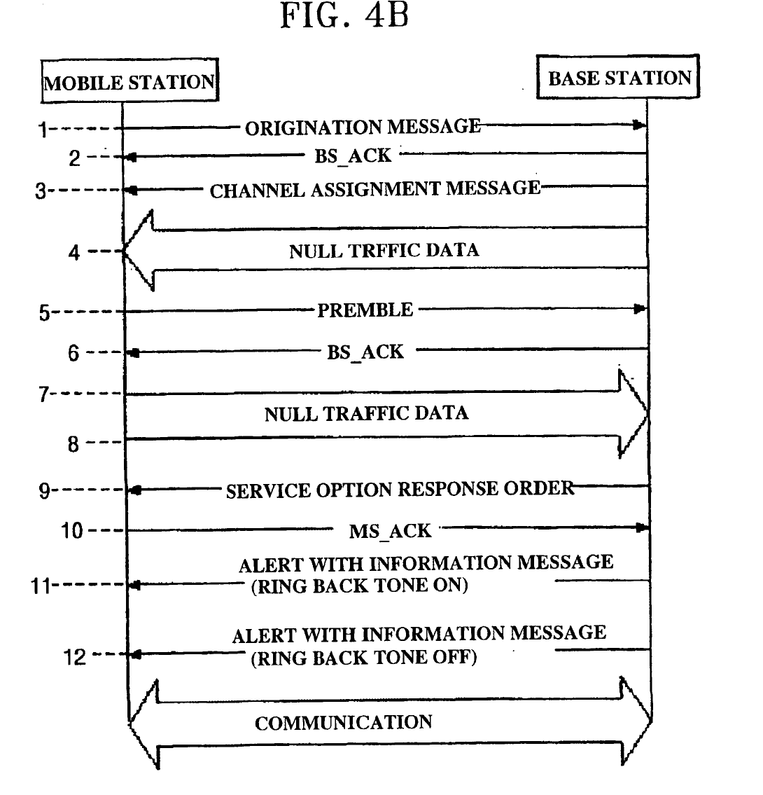

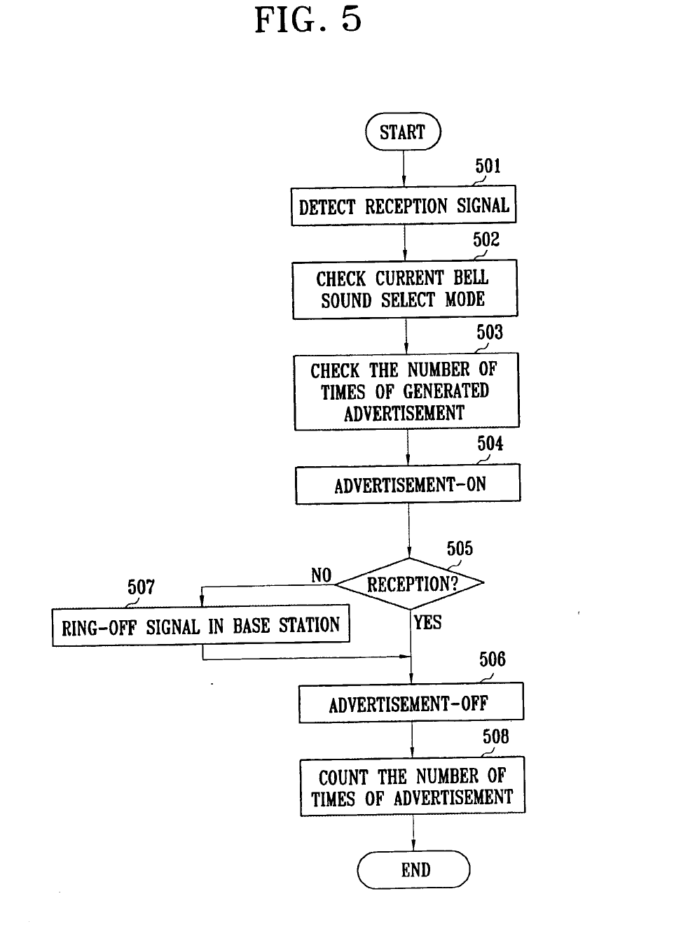

First, an advertisement method using an incoming call sound will be described with reference to FIGS. 4A and 5.

FIG. 4A is a view for explaining an incoming call signal procedure of a mobile phone terminal 10B at the reception side. The terminal incoming call signal procedure between a mobile station (MS) and a base station (BS) is divided and illustrated into thirteen procedures. These procedures are generally used and thus the detailed description thereof will be omitted. At a ring-on state of a process 12 where an incoming call sound rings a CPU 111 of the mobile phone terminal 10B controls a memory 112 to read out an incoming call sound (a bell sound) and generate the ring sound via the ring generator 12 to thereby enable a called party to receive a call. As soon as the called party receives the telephone call (process 13) a connection is accomplished. Here, a software of the CPU 111 in the control block 11 within the mobile phone terminal 10B is properly modified to then cause a downloaded advertisement music or a message to be listened to or watched by the called party instead of the incoming call sound of the process 12. That is, as shown in FIG. 5, the reception-side mobile phone terminal 10B checks a current bell sound select mode (step 502) if a reception signal has been detected (step 501). The bell sound such as a melody, vibration and a downloaded advertisement is selected by the user. In the result of step 502, if an advertisement has been selected as a current bell sound the mobile phone terminal 10B compares the number of times of the generated advertisements with the number of times designated during downloading, and checks whether a current advertisement can be transferred as a ring sound (step 503). In the result of step 503, if the number of times of the generated advertisements is smaller than the designated number of times, that is, a current state is a state where an advertisement can be generated, the CPU 111 of the mobile phone terminal 10B controls the memory 112 to then read out an advertisement stored in the memory 112 to thereby ring as a telephone bell sound (step 504). The called party hears an advertisement output from the mobile phone terminal 10B to then check that a telephone call reaches. The mobile phone terminal 10B turns off an advertisement to stop the output of the advertisement (step 56) if the user has received the call to thus make both parties communicate with each other (step 505). If the user is absent or does not receive the call, and thus the caller disconnects the call to thereby enable the base station 30B to transfer a call interruption signal to the called party (step 507), the mobile phone terminal 10B stops the output of the advertisement (step 506). Here, in the case that an advertisement is stopped due to a user's phone reception, it is checked that the user has listened to or watched the advertisement and then counts the number of times of the advertisements (step 508). In the case that a user has completely listened to or watched all the downloaded advertisements in step 504, the mobile phone terminal is automatically converted into a general mode in which the user has listened to or watched a general bell sound or vibration sound in his or her phone terminal, and recognizes that the phone mode has been changed into a general mode. In step 508, a method for counting the advertisements is classified into two. One is a method for counting the advertisement at a terminal in which a bell sound can be selected as a melody or vibration during downloading an advertisement, and the terminal counts the number of times of the advertisements whenever the advertisement is output as an advertisement ring sound. The other is a method for counting the advertisement at a mobile communication service provider to thereby transfer the number of times of the advertisements to the system operator 60, in which the terminal should be set so that it is not possible to be changed into a bell sound mode or a vibration mode. The system operator 60 is reported from the exchanger that there has been a normal communications service from that time once an advertisement has been transferred to a terminal. Here, the system operator recognizes that the user has listened to or watched the advertisement and then the call has accomplished to then be counted as the number of times in listening to or watching the advertisements.

There are various methods in listening to or watching an advertisement after a user makes a phone call. First, one advertisement is repeatedly listened to or watched for a designated number of times and then a next advertisement is downloaded to successively listen to or watch the downloaded advertisement.

Second, a number of advertisements are downloaded at a time and are listened to or watched in turn. Third, a number of advertisements are downloaded at a time, one advertisement is successively listened to or watched by a designated number of times ad then a next advertisement is successively listened to or watched.

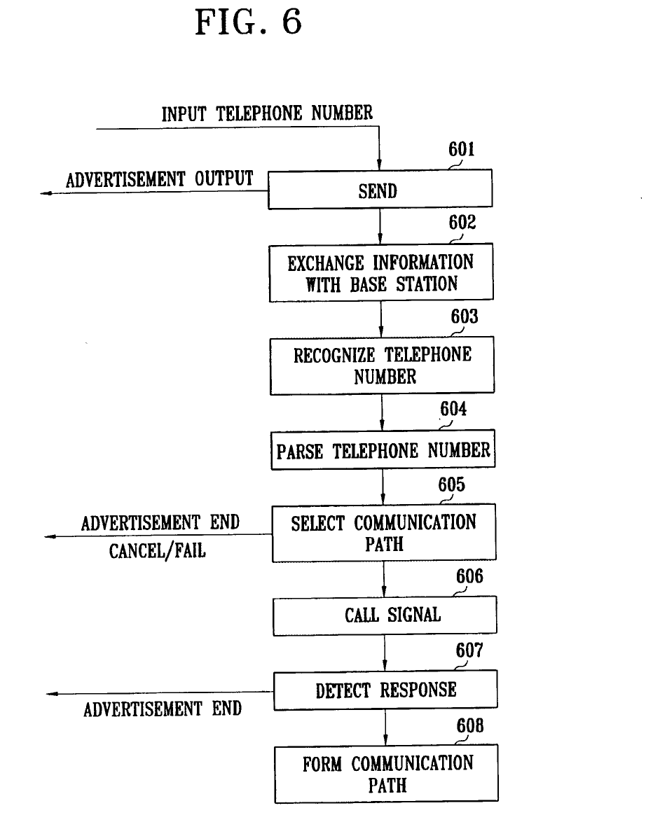

Next, an advertisement method using a predetermined time from start of an outgoing call to receipt of a called party signal such as a response, a busy signal and an absence signal in the mobile phone terminal will be described with reference to FIGS. 4B and 6.

FIG. 4B is a view for explaining an outgoing call signal procedure of a mobile phone terminal 10A at the transmission side. When a user presses a key pad on the mobile phone terminal 10A and then enters a called party's telephone number and a send button in turn to start an outgoing call, a series of messages are communicated between the base station (BS) and the mobile station (MS) according to the procedure shown in FIG. 4B. Here, the mobile station (MS) maintains a non-sound state for a predetermined time (processes 1-11), a ring back tone is turned on. Then, the outgoing-side mobile phone terminal 10A recognizes the ring back tone signal and generates the stored rig back tone signal.

Therefore, if a called party has responded, a call is accomplished (processes 11-12). Here, the software of the mobile phone terminal 10A is properly modified to thereby enable the user to listen to or watch the advertisement stored in the mobile phone terminal 10A in advance, by use of the non-sound state and the ring back tone ringing time. That is, as shown in FIG. 6, if a subscriber presses a telephone number for the mobile phone terminal 10B or the general telephone terminal 20B of a called party through his or her mobile phone terminal 10A and then presses a SEND button (step 601), a DTMF tone is generated and then sent to the base station 30A at a caller side. In this case, the mobile phone terminal 10A outputs an advertisement downloaded and stored in the memory 112 in advance so that the caller can watch or listen to the output advertisement. Also, the mobile phone terminal 10A exchanges information with the base station 30A (step 602), ascertains an authentication code assigned to a subscriber of a caller side, and then recognizes a desired telephone number (step 603). The base station 30A parses the telephone number recognized via step 603 (step 604) (step 604), and forms a communication path to the mobile phone terminal 10B at the reception side via the base station 30B of a corresponding subscriber if the telephone number is one of the numbers subscribed in the same mobile communication service company (step 605). If the telephone number of the called party is one of the general telephone numbers not the same mobile communication service company or one of the numbers subscribed in another mobile communication service company, the base station 30A forms a communication path with a called party via the exchanger 40A of the subscriber side, that is, via the corresponding exchanger 40B and the base station 30B at the mobile communication service company side in the case that the called party is the mobile phone terminal 10B (step 605). If the called party is the general telephone terminal 20B, a call is transferred to the telephone terminal 20B of the called party via the exchanger 50B of the called party, to thereby form a communication path. The called party base station 30B and the station exchangers 40B and 50 ascertain whether the called party can receive the call and notify the ascertained result to the caller side exchanger 40A and the base station 30A. The caller side base station 30A ascertains whether the notified signal is in a possible communication state, and then notifies the ascertained result to the mobile phone terminal 10A of the subscriber at the caller side. If the caller side mobile phone terminal 10A is notified that a called party is busy, an advertisement output is stopped and then a signal indicating that the called party is busy is output. If the mobile phone terminal 10A is notified that the called parts is in a possible communication an advertisement output is maintained. Here, the called party side base station 30B and the station exchangers 40B and 50B transfer a call signal to the mobile phone terminal 10B or the general telephone terminal 20B at the called party side, so that the called party can recognize that there is a call (step 606). Meanwhile, if a called party response signal with respect to a call signal is transferred via the exchanger 40A and the base station 30A, or a communication end signal is transferred at a caller side (step 607), the mobile phone terminal 10A stops an advertisement output. Then, in the case that a normal call is accomplished, a communication path is formed (step 609).

The mobile phone terminals 10A and 10B count the number of times in which an advertisement is listened to or watched, report the counted result to the system operator 60, and make a predetermined benefit such as an advertisement listening and watching fee assigned to the subscribers who have listened to or in watched the advertisement. According to a method for counting the number of times of listening to or watching an advertisement, the mobile phone terminals 10A and 10B accumulate the number of times of listening to or watching the advertisement whenever an advertisement ring sound is transmitted, and notify the accumulated number of times to the system operator 60 whenever the subscribers gain access to the system operator 60 using a mobile web browser in the mobile phone terminals 10A and 1013 in the gross. Otherwise, if the advertisements downloaded in the mobile phone terminals have been listened to or watched, the result is automatically reported to the system operator using SMS or the mobile communication service company gives information about the number of times of attempting a call of the subscriber to the system operator 60, so that the system operator 60 counts the number of times of listening to or watching an advertisement Here, benefits allowable according to the number of times of listening to or watching an advertisement may contain a wide variety such as reduction of fee for a telephone call, a point accumulation, discount in price of a new terminal purchase, etc. That is, according to a method of reducing a fee for a telephone call, the number of times of an advertisement which has been listened to or watched by a subscriber is counted and part of the fee for a telephone call is deducted due to the benefit with respect to the listening to or watching of the advertisement through a bill issued from the mobile communication service company in which a benefit amount when listening or watching of the advertisement is determined. Also, a benefit with respect to listening or watching an advertisement is accumulated as a point in a system operator, and the accumulated points are provided when the subscriber wants the accumulated points as a cash or another purpose. Alternatively, when a subscriber wants to purchase a new terminal, part of the purchase price of the terminal is provided as a discount price in negotiation with a terminal seller shop, and the amount with respect to the discounted price is paid on an installment basis while using an advertisement service and an electronic commerce service.

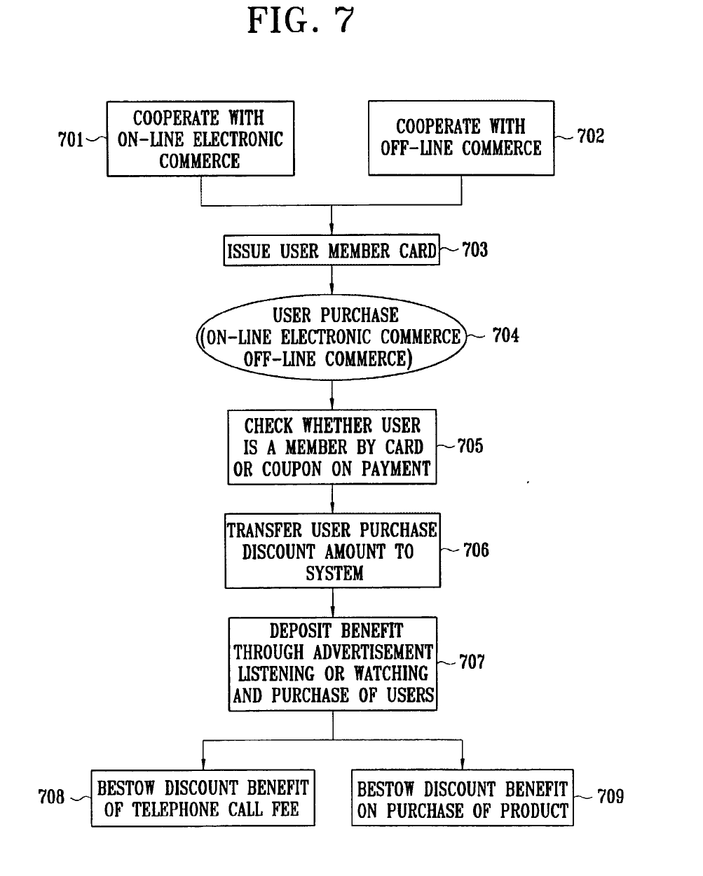

Meanwhile, in order to provide an electronic commerce service for inducing a purchase after listening to or watching an advertisement, the system operator 60 should cooperate with companies which provide product sale or service. When such cooperative companies provide a user with product purchase or service, a discount benefit should be bestowed to the user based on an agreement between the system operator 60 and the cooperative companies. In the case that product purchase or service provision of the cooperative companies is not accomplished in the cooperative companies but in circulation companies such as separate on-line electronic commerce and off-line commerce, the system operator 60 enables users to receive the same benefits as those assigned to the users provided with products or services of the cooperative companies. This will be described in more detail with reference to FIG. 7.

FIG. 7 is a flow chart view for explaining a procedure that a user purchases a product in a cooperative company in association with the system operator 60 and a reserve processing procedure with respect to Such a purchase.

In FIG. 7, the system operator 60 should be associated with an on-line electronic commerce and off-line commerce in order to bestow a benefit to a user with respect to a purchase (steps 701 and 702). Then, the cooperative company issues for a user a card or coupon for verifying that the user is a subscribed member on purchase and deliverers the same to the user (step 703). That is, the system operator 60 authenticates a benefit with respect to the user's purchase in the cooperative company, by use of the card or coupon issued from the system operator or a card issued from the cooperative company. A user purchases a product in a cooperative on-line electronic commerce system 71 and an off-line commerce system 72 (step 704). In this case, the user presents a card or coupon provided in the system operator 60 to make him or her confirmed as the member (step 705). If the user has been confirmed as a member at the seller side through step 705, a discount amount is notified to the system operator 60 (step 706). The system operator 60 deposits a benefit amount with respect to a user's purchase on the basis of the notified contents (step 707). At the same time, the system operator 60 deposits the benefits with respect to the advertisement listening or watching as well as the purchase. The kind of the benefits is selected according to an operation policy of the system operator 60. In the case that a discount benefit of a mobile phone terminal is selected, the system operator 60 notifies the mobile communication service company of the deposited amount, to thereby enable a user to be bestowed with a discount benefit at a bill issued for a mobile communication fee (step 708). In the case that a subsidy benefit is selected on purchase of a product, the system operator 60 bestows a benefit with respect to a purchase price on purchase of a product such as a new terminal on a user, to lower a burden with respect to a purchase price (step 709).

The embodiment has been described with respect to a case that a downloaded advertisement is listened to or watched, and a benefit is bestowed on purchase. However, it is apparent to a person who has an ordinary skill in the art that music such as a variety of melodies is downloaded so as to be listened to. In this case, a user pays a utilization fee for a desired music and listens to the downloaded music, which is a difference between the advertisement and the music. In the case of the melody download, a benefit with respect to the advertisement listening or watching and the purchase is to allow the user to download it freely The present invention is not limited in the above-described embodiment. It is apparent to a subject skilled in the art that there are many variations and modifications.

### INDUSTRIAL APPLICABILITY

As described above, the method and system providing an advertisement using a tone of ringing sounds of a mobile phone terminal, and a commercial transaction service in association with the same according to the present invention can advertize using a time in which a ringing tone is produced before a telephone connection is made, or a standby time, to thereby enhance the maximum advertisement effect without having no harm to a caller and a called parts. Also, it is possible to advertize in diverse form according to a class of members by using member information, and provides an effect of refunding a predetermined amount of money in return to an advertisement listening or watching. Further, the no present invention provides an effect of reducing a boring time before connection of communications by listening a melody instead of an advertisement. In addition, the benefit such as a discount of a mobile communication fee or a point accumulation on purchase of a corresponding advertisement product, and a subsidy on purchase of a new terminal, in association with the advertisement listening or watching through a mobile phone terminal, is bestowed to thereby enhance an advertisement efficiency and lower an expense burden with respect to a users purchase of a terminal. Further, the present invention is widely applied to other products as well as a terminal, to thereby bestow a discount benefit with respect to a purchase price on purchase of a product.

1. A method providing an advertisement using a tone of ringing sounds of a mobile phone terminal, and a commercial transaction service in association with the same, the advertisement and commercial transaction providing method comprising the steps of:
(a) accessing an advertisement service provider, downloading an advertisement and storing the downloaded advertisement;
(b) outputting the advertisement stored in step (a) as a phone call reception ringing tone, and outputting the advertisement stored in step (a) as a phone call transmission ringing tone for a predetermined time, to make a caller and a receiver listen to or watch the advertisement;
(c) interrupting the advertisement which is output in step (b) if a phone call is connected between the caller and the receiver;
(d) counting the number of the listening and watching of the advertisement in step (b) and notifying the counted result to the advertisement service provider;
(e) purchasing a product of a sponsor company in association with the listening and watching of the advertisement in step (b); and
(f) providing advantages designated with respect to the number of the listening and watching of the advertisement in step (d) and the purchase of the product in step (e).

2. The method providing an advertisement and a commercial transaction service in association with the same of claim 1, wherein said step (a) comprises the steps of:
(a1) allowing users to be subscribed as members and constructing personal information including name, age, sex, job and hobby as a database;
(a2) receiving advertisements formed in various forms such as music, messages, still images and motion images from an advertisement sponsor and forming the received advertisements as a database;
(a3) transmitting a selectable menu to a user who is accessed on the Internet via a mobile web browser;
(a4) informing the user of the number of times of listening or watching the advertisement if the user selects an inquiry of the number of times of listening or watching the advertisement, receiving the completely listened or watched advertisement and user information if the user selects an advertisement download to thereby judge whether an advertisement can be downloaded, and downloading an advertisement deletion instruction to a mobile phone terminal of the user if the user selects a stop of use, among the transmitted menu of step (a3);
(a5) selecting and downloading an advertisement appropriate for an accessed user among the advertisements on the database formed in step (a2) if an advertisement can be downloaded and transmitting a message that it is impossible to download the advertisement to the user if the advertisement cannot be downloaded, in the result of judgement of step (a4), and
(a6) transferring an end message to the user if the advertisement has been completely downloaded.

3. The method providing an advertisement and a commercial transaction service in association with the same of claim 2, wherein said step (a5) comprises of the step of selecting an advertisement to be downloaded using member information of the user constructed in step (a1).

4. The method providing an advertisement and a commercial transaction service in association with the same of claim 1, wherein said step (b) comprises the steps of:
(b1) designating one of melody, vibration and advertisement as a bell sound mode.
(b2) checking a current bell sound mode designated in step (b1) if a reception signal is detected;
(b3) comparing the number of times of the generated advertisements with the number of times selected during downloading the advertisement, if the advertisement is designated as the current bell sound in the result of checking in step (b2) and checking whether the advertisement can be output as a ring sound; and
(b4) outputting the downloaded and stored advertisement as a ring sound if the number of times of the generated advertisements is smaller than the selected number of times in the result of checking in step (b3) and thus it is possible to output the ring sound.

5. The method providing an advertisement and a commercial transaction service in association with the same of claim 1, wherein said step (b) comprises the steps of;
(b1) pressing a telephone number and a SEND button in sequence to start an outgoing call:
(b2) outputting the downloaded and stored advertisement to be listened to or watched by the caller according to the outgoing call start of step (b1); and
(b3) interrupting the advertisement output in step (b2) and outputting a busy signal to be listened to or watched by the caller if the transmitted ring back tone signal is recognized as the busy signal and maintaining an advertisement output if the ring back tone signal is recognized as a communication possible state.

6. The method providing an advertisement and a commercial transaction service in association with the same of claim 5, wherein said step (b2) outputs a melody instead of an advertisement.

7. The method providing an advertisement and a commercial transaction service in association with the same of claim 4, wherein said step (c) interrupts an advertisement if a call interruption signal is received as a reception response and a non-response of the user.

8. The method providing an advertisement and a commercial transaction service in association with the same of claim 5, wherein said step (c) interrupts an advertisement to then form a communication path if a reception response signal of the called party has been transmitted interrupts an advertisement if an absence message or an end communication signal has been recognized as a non-response of the called party, and outputs the absence message or the non-response message so as to be listened to or watched by the caller.

9. The method providing an advertisement and a commercial transaction service in association with the same of claim 1, wherein said step (d) accumulates the number of times of listening to or watching the advertisement in the mobile phone terminal, notifies the accumulated number of times in the gross whenever the mobile phone terminal is accessed to the advertisement, consistently reports the number of times of listening to or watching the advertisement until the number of times is automatically collected in the mobile phone terminal, using SMS, or provides information with respect to the number of times of attempting the user's call in the mobile communication service provider to thereby count the number of times of listening to or watching the advertisement.

10. The method providing an advertisement and a commercial transaction service in association with the same of claim 1, wherein said step (e) comprises the steps of:
(e1) providing product sale and service of cooperative companies in association with an on-line electronic commerce and an off-line commerce;
(e2) issuing a card and coupon to authenticate a benefit with respect to product purchase: and
(e3) notifying a discount benefit when the authenticated user uses the product purchase and the service of the cooperative company on the on-line and off-line commerce.

11. The method providing an advertisement and a commercial transaction service in association with the same of claim 1, wherein said step (f) bestows a discount of a fee of a mobile phone call and a discount benefit on purchase of products including a terminal, on the user.

12. A system providing an advertisement using a tone of ringing sounds of a mobile phone terminal, and a commercial transaction service in association with the same, the advertisement and commercial transaction providing system comprising:
a system operator for selecting an appropriate advertisement among prestored advertisements, downloading the selected advertisement to a mobile phone terminal which is designated by a subscriber accessed to the system operator, and providing advantages determined with respect to listening and watching the downloaded advertisement and purchasing a product:
the mobile phone terminal outputting the stored advertisement as a phone call reception ringing tone, and outputting the advertisement stored as a phone call transmission ringing tone for a predetermined time, to make a caller and a receiver listen to or watch the advertisement, counting the number of the listening and watching of the advertisement, and notifying the counted result to the system operator;
a connector connecting between the system operator and the mobile phone terminal, and
a commercial transaction system operator providing a purchase and service of products of a sponsored company of the system operator, and providing advantages vehicle are provided during purchase and use of the product and service to the system operator.

13. The system providing an advertisement and a commercial transaction service in association with the same of claim 11, wherein said system operator comprises:
a member database forming subscribed member information as a database and storing the same,
an advertisement database forming advertisements formed in various forms such as music, messages, still images and motion images provided from an advertisement sponsor as a database and storing the same, and
an operator server for searching the member database, selecting an advertisement appropriate for an accessed member subscriber based on the searched result from the advertisement database and downloading the selected advertisement, counting the number of times of listening to or watching the downloaded advertisement or receiving the number of times of listening to or watching the advertisement from the mobile phone terminal to thereby pay a designated benefit, and bestowing a benefit transmitted from the commercial transaction system.

14. The system providing an advertisement and a commercial transaction service in association with the same of claim 13, wherein said system operator issues a card or coupon and authenticates a benefit with respect to product purchase and service utilization of the user on the commercial transaction system.

15. The system providing an advertisement and a commercial transaction service in association with the same of claim 14, wherein said system operator bestows a discount benefit of a fee for a mobile phone call in association with the mobile communications service provider.

16. The system providing an advertisement and a commercial transaction service in association with the same of claim 14, wherein said system operator deposits the number of times of listening to or watching the advertisement as a point and bestows a benefit as a cash or other purposes.

17. The system providing an advertisement and a commercial transaction service in association with the same of claim 16, wherein said system operator discounts part of a purchase price of a mobile phone terminal in association with a mobile phone terminal manufacturer and bestows a benefit in which the discounted amount can be paid on installment for a designated period using an amount deposited by the advertisement listening or watching or the product purchase.

18. The system providing an advertisement and a commercial transaction service in association with the same of claim 12, wherein said mobile phone terminal comprises:
a memory for storing an advertisement downloaded from the system operator: and
a CPU for outputting, an advertisement stored in the memory for a predetermined time on the basis of an incoming call ring sound and from start of a phone outgoing call to reception of a reception response of a called party, a busy signal and an absence signal, so as to be listened to or watched and containing a program for counting the number of times of listening to or watching the advertisement.

19. The system providing an advertisement and a commercial transaction service in association with the same of claim 12, wherein said connector is a mobile web browser.

20. The system providing an advertisement and a commercial transaction service in association with the same of claim 11 wherein said commercial transaction system is an on-line electronic commerce system and an off-line commerce system so that a product of the cooperative company is accomplished on the on-line and off-line commercial transaction system in association with the system operator.
